(19) United States
(12) Patent Application Publication
(10) Pub. No.: US 2014/0005580 A1
(43) Pub. Date: Jan. 2, 2014

(54) Massage Device

(71) Applicant: Fun Factory GmbH, Bremen (DE)

(72) Inventors: Heinrich-Maria BRUEGGEMANN, Munderkingen (DE); Norbert EIGLER, Meinerzhagen (DE)

(21) Appl. No.: 13/932,517

(22) Filed: Jul. 1, 2013

(30) Foreign Application Priority Data
Jul. 2, 2012 (DE) 10 2012 013 063.5

(51) Int. Cl. A61H 15/00

(52) U.S. Cl. CPC A61H 15/0078
USPC 601/118

(57) ABSTRACT

A massage device includes at least one massage section with an essentially cylindrical rubber-elastic outer sheath, with at least one electromotive drive arranged in the massage device and non-rotatably mounted therein, and with a device arranged in the massage section and non-rotatably mounted therein for generating deformations of the rubber-elastic outer sheath. The device includes a multitude of plunger guides extending radially to the massage section and supporting plungers therein, and a cam shaft connected with the electromotive drive and acting on the ends of the plungers facing away from the rubber-elastic outer sheath, thereby the plungers being radially moved towards the massage section, and wherein the rubber-elastic outer sheath is connected with the ends of the plungers of the rubber-elastic outer sheath facing towards the rubber-elastic outer sheath. As an alternative to the plungers, eccentric wheels with roller wheels supported on eccentric bearing pins may be used.

### FIELD OF THE INVENTION

The invention relates to a massage device comprising at least one massage section with an essentially cylindrical rubber-elastic outer sheath, with at least one electromotive drive arranged in the massage device and non-rotatably mounted therein, and with a device arranged in the massage section for generating deformations of the rubber-elastic outer sheath.

### PRIOR ART AND BACKGROUND OF THE INVENTION

From the practice as well as from the document U.S. Pat. No. 6,190,307, a massage device having the structure mentioned above is known in the art. Herein, a deformation element is mounted on an output shaft of the electromotive drive and rotates and revolves therewith, the deformation element having at least one projection or a protruding roller that presses in a revolving manner from inside the rubber-elastic outer sheath against the latter and deforms the outer sheath in the area of the deformation element towards outside. By the consequently revolving deformation of the rubber-elastic outer sheath, ultimately the massage effect is obtained.

It is disadvantageous, in this prior art device, that for generating the massage effect, a continuous force effect of the electromotive drive is required. Furthermore, due to the revolving deformation element, disturbing friction forces between the deformation element and the rubber-elastic outer sheath have continuously to be overcome. In particular, it is disturbing that the ball cage normally used in this prior art devices and having balls as deformation elements can be stopped or at least slowed down by external forces, which is found considerably disturbing in some modes of use. This has to do with that because of the ball cage necessarily being arranged and revolving immediately below the rubber-elastic outer sheath, due to the effective torques, an influence on the rotating speed is possible with application of a relatively low force. Further, for changing the pattern of the massage movements, the deformation element as a whole has to be modified or replaced.

### TECHNICAL OBJECT OF THE INVENTION

It is therefore the technical object of the invention to improve a massage device, the massage movements of which are caused by deformations of a rubber-elastic outer sheath, such that a stable massage pattern is obtained with comparatively simple means. Furthermore, it is the technical object of the invention to obtain a higher flexibility in designing the massage pattern with lower efforts in production than for the prior art devices.

### BASICS OF THE INVENTION AND PREFERRED EMBODIMENTS

For achieving this technical object, the invention teaches a massage device comprising at least one massage section with an essentially cylindrical rubber-elastic outer sheath, with at least one electromotive drive arranged in the massage device and non-rotatably mounted therein, and with a device arranged in the massage section and non-rotatably mounted therein for generating deformations of the rubber-elastic outer sheath, wherein the device for generating deformations of the rubber-elastic outer sheath comprises a multitude of plunger guides extending radially to the massage section and supporting plungers therein, and a cam shaft connected with the electromotive drive and acting on the ends of the plungers facing away from the rubber-elastic outer sheath, thereby the plungers being radially moved towards the massage section, and wherein the rubber-elastic outer sheath is connected with the ends of the plungers facing towards the rubber-elastic outer sheath or rests thereagainst under rubber-elastic tension.

As an alternative to the plungers, it may be provided that the device for generating deformations of the rubber-elastic outer sheath comprises a multitude of eccentric wheels to be rotatably driven by means of the electromotive drive, which eccentric wheels comprise at least one freely rotatable roller wheel each supported on at least one eccentric bearing pin, wherein the roller wheel acts on the inside of the rubber-elastic outer sheath and moves it radially towards the massage section. Then the rubber-elastic outer sheath is connected with the roller wheel at least when deforming the rubber-elastic outer sheath.

In the simplest case, the connection of plungers or roller wheels with the rubber-elastic outer sheath is achieved by that the rubber-elastic outer sheath rests against an outer surface of the device for generating deformations. Then, a movement of the plungers in a radial direction or the rotation of the eccentric wheels will lead to the deformation, by that the plungers or roller wheels so to speak press the rubber-elastic outer sheath away from the device.

In the first alternative, the only movable components are an output shaft of the electromotive drive and the cam shaft connected with this output shaft. The electromotive drive itself or its housing is non-rotatably mounted in the massage device, same as the device for generating deformations of the rubber-elastic outer sheath.

In the second alternative, the eccentric wheels are supported on eccentric wheel axes of rotation, which are arranged on a circle around a central drive shaft connected with the electromotive drive, and are oriented essentially in parallel to the drive shaft. On one eccentric wheel axis of rotation, several eccentric wheels may be mounted in an axially spaced manner. The eccentric wheels may be attached non-rotatably on the eccentric wheel axis of rotation and for instance be driven by the central drive shaft by means of gear wheels, drive belts or the like, in particular by means of a spur gear drive. An eccentric bearing pin may be mounted directly on an eccentric wheel, or in a support element or support cage radially extending over the outer circumference of the eccentric wheel. It will be useful, if the outer circumference of an eccentric wheel outside the area supporting a roller wheel will not protrude beyond an outer surface of the device for generating deformations of the rubber-elastic outer sheath and will preferably rotate immediately inside the outer surface. A roller wheel has a radius that is larger than the distance of the eccentric wheel axis of rotation from the outer circumference of the eccentric wheel. If a support element is provided for the roller wheel, the components of the support element, viewed in an axial projection, will not protrude beyond the roller wheel.

A multitude of advantages are achieved by the invention. Firstly, different from prior art, the return force of the rubber-elastic outer sheath will add to the force on the cam shaft with respect to those plungers that were driven radially outwards by the cam shaft, thus deforming the rubber-elastic outer sheath. In other words, plungers moving radially inwards due to the action of the rubber-elastic outer sheath and the cam shaft will support force-wise the rotational movement of the cam shaft. Thereby results an overall lower power or energy consumption of the electromotive drive. Analogous considerations apply for the roller wheels, since after exceeding a peak of the deformation of the rubber-elastic outer sheath they will also be pushed back by the outer sheath, thus the rotation of the eccentric wheel being assisted. Secondly, electrical cables, in particular those leading to the electromotive drive, can be mounted outside the device for generating deformations and inside the rubber-elastic outer sheath, since said device itself does not rotate. Suitably, the cables are laid between the plungers or eccentric wheels/roller wheels. This permits for instance to mount the electromotive drive on the one hand and an operating and/or control unit (if applicable including an electrical energy storage) on the other hand on opposite sides of the device for generating deformations of the rubber-elastic outer sheath, referred to the longitudinal extension of the massage device. Further, in the area of the massage section in the plunger variant, a revolving massage movement is generated, without the necessity of operating rotating components inside the rubber-elastic outer sheath, thus disturbing friction and wear being prevented in an effective way. In the eccentric wheel variant, this advantage will also apply, since the roller wheels can roll off inside on the rubber-elastic outer sheath and will also act in a deforming manner without friction losses. Finally, by variation of the number and the arrangement of the plunger guides and the plungers guided therein on the one hand and the configuration of the cam shaft on the other hand, the most various movement patterns and consequently massage effects can be obtained or modified and adapted to certain applications in a technically very simple way. Basically, for instance an exchange of a cam shaft by another cam shaft having a different cam profile is already sufficient for this. Thus, there is obtained an extremely high variability in production with very low costs, since it is only necessary to provide different cam shafts. Ultimately, it should also be noted that compared to prior art using for instance a revolving ball cage, a novel massage effect is created. In this context, it should further be noted that by variation of the cam height of the cam shafts, plunger strokes of different heights can also be obtained. Ultimately, movements in a radial direction, referred to the cylindrical part of the massage device, are also made possible outside the rubber-elastic outer sheath, the strokes of which are higher than those of for instance prior art devices with a revolving ball cage. It is also possible, with the plunger guiding planes described below, to provide different strokes of the plungers, as required for a given massage pattern.

Within the framework of the invention, multiple variants of potential improvements exist, as will be described in the following.

It is preferred that in the device for generating deformations of the rubber-elastic outer sheath, a multitude of, in an axial direction referred to the massage section, spaced plunger guiding or eccentric wheel planes are provided. Basically, thereby a type of device for generating deformations is obtained that corresponds to a cylindrical outer surface, in this cylindrical outer surface a multitude of plungers being movable back and forth in a radial direction by the action of assigned cams of the cam shaft. As an alternative, the roller wheels will periodically protrude beyond this cylindrical outer surface. Preferably, the plunger guides and plungers within a plunger guiding plane are distributed uniformly over the circumference of the cylindrical outer surface, a non-uniform not being excluded, being however less preferred. Analogous considerations apply for the arrangement of the eccentric wheels. The number of the plunger guiding or eccentric wheel planes may in principle be arbitrary, depending on the size of the massage section. In the practice, it will be recommended that the number of the plunger guiding or eccentric wheel planes is in the range from 2 to 20, in particular from 3 to 6. The number of the plunger guides or eccentric wheels in each plunger guiding or eccentric wheel plane may be identical or different and is preferably between 2 and 20, in particular 3 or 4 and 8.

In another preferred embodiment, the plunger guides of adjacent plunger guiding planes are displaced relative to each other, in particular centrally displaced relative to each other. Of course, different displacements, regular or irregular, are also possible, if this is desirable according to a massage pattern to be adjusted in the area of the massage section. Analogous considerations apply for the variant with eccentric wheels.

In a special embodiment having an independent relevance, the electromotive drive or its output axis and the cam shaft is tilted by an angle a in the range from 0° to 20°, in particular 0.5° to 10° with respect to the axis of the device for generating deformations. Thereby, it is achieved that the area of the massage device, where the electromotive drive is mounted, is set into a precision movement (referred to the massage section), i.e. the area of the massage device, where the electromotive drive is mounted, moves on a precision cone relative to the massage section.

For energy reasons, it is advantageous, if the rubber-elastic outer sheath and its connection with the ends of the plungers facing towards the rubber-elastic outer sheath are adapted such that the return forces and return travels of the rubber-elastic outer sheath are adapted for a complete return of the plungers against the cam shaft. In other words, the plungers move in a radial direction without play between the rubber-elastic outer sheath and the cams of the cam shaft. Thereby, a particularly smooth running and quietness of the massage device is obtained.

As mentioned above, it is preferred that an operating and/or control unit for controlling the electromotive drive on the one hand and the electromotive drive on the other hand are mounted on opposite sides of the device for generating deformations of the rubber-elastic outer sheath, referred to the axial direction of the device. This also guarantees an anatomically correct positioning of the massage section with simultaneous manual reachability of the operating and/or control unit. In principle, a storage for electrical energy may be mounted anywhere inside the massage device, it will however normally be useful to accommodate this energy storage in the area of the operating and/or control unit. As already noted, said different assemblies can easily be connected by electrical cables inside the rubber-elastic outer sheath, and consequently any configuration of the arrangement may preferably be chosen.

In an improvement of the invention, the massage device may also include a remote control unit that is connected with the operating and/or control unit of the massage device. This connection may for instance be made by electrical cables and/or optical cables. However, a connection by electromagnetic waves is also possible, for instance radio waves or light waves, in particular in the infrared wavelength range. In the case of a wireless or cableless connection, the remote control unit will of course include at least one transmitter unit, and the operating and/or control unit mounted in the massage device will include a receiver unit. The details of the configuration of such a remote control system are well known to the man skilled in the art and do not require a detailed description here.

### BRIEF DESCRIPTION OF THE DRAWINGS

In the following, the invention will be explained in more detail with reference to embodiments representing examples of execution only. There are:

FIG. 1: a diagrammatical cross-section of a massage device according to the invention,

FIG. 2a-f: different views of an assembly for a massage device according to the invention comprising the electromotive drive as well as the device for generating deformations of the rubber-elastic outer sheath,

FIG. 3a-e: different views of an embodiment of a plunger guide arrangement,

FIG. 4: a diagrammatical representation of a unit comprising the electromotive drive and the device for generating deformations, in an alternative embodiment,

FIG. 5: a front view of the subject matter of FIG. 4, viewed in the direction of the device for generating deformations,

FIG. 6: a sectional drawing of the subject matter of FIG. 5, viewed in the direction A-A,

FIG. 7: a detailed representation of a plunger in two viewing directions (a and b, view b being in the direction of the viewing direction C-C of Figure a),

FIG. 8: a detailed representation of a cam wheel in two viewing directions (a and b, view b being in the viewing direction D-D of view a),

FIG. 9: a sectional representation of the subject matter of FIG. 6 in plane B-B,

FIG. 10: a sectional representation of the subject matter of FIG. 6 in plane E-E without inserted plungers,

FIG. 11: an alternative device for generating deformations including roller wheels,

FIG. 12: a top view of the subject matter of FIG. 11, in an axial direction,

FIG. 13: a cross-sectional representation of the subject matter of FIG. 11 in plane A-A, and

FIG. 14: a top view of the subject matter of FIG. 11, in a radial direction.

### DETAILED DESCRIPTION

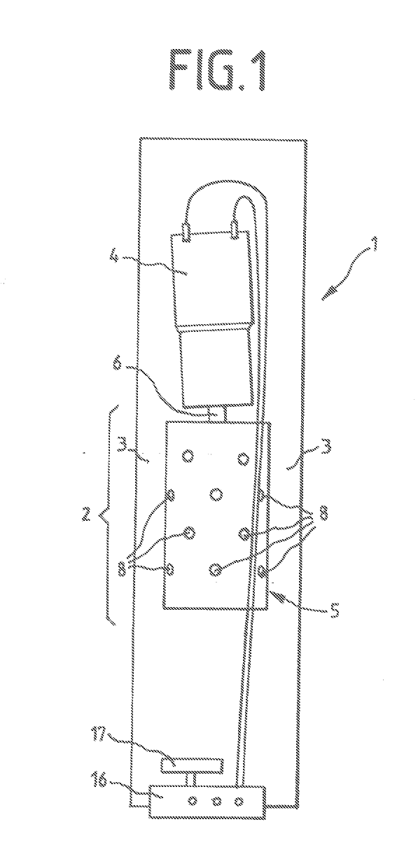

In FIG. 1 can be seen a massage device 1 having an essentially cylindrical outer shape. Of course, different configurations are also possible, in particular in the areas of one or both ends of the massage device. There is shown a massage section 2, at least in the area of the massage section 2 the massage device 1 being equipped with a rubber-elastic outer sheath 3. In this embodiment, the rubber-elastic outer sheath 3 extends beyond the massage section 2. Inside the rubber-elastic outer sheath 3, an electromotive drive 4 and a device 5 for generating deformations of the rubber-elastic outer sheath 3 are provided. Both (with the exception of the output shaft 6 of the electromotive drive 4) are non-rotatably embedded in the rubber-elastic outer sheath 3. Furthermore is shown an operating and/or control unit 16 as well as an energy storage 17 (battery or accumulator).

The device 5 for generating deformations of the rubber-elastic outer sheath 3 comprises a multitude of plunger guides 7 extending radially to the massage section 2 and plungers 8 guided therein. Inside, a (not shown) cam shaft is mounted, which is connected with the output shaft 6 of the electromotive drive 4. The cams of the cam shaft act on the ends of the plungers 8 facing away from the rubber-elastic outer sheath 3 and move the plungers 8 in a radial direction, referred to the massage section 2 or to the device 5 for generating deformations, respectively. The ends of the plungers 8 facing towards the rubber-elastic outer sheath 3 rest against the inner side of the rubber-elastic outer sheath 3 and are thus connected therewith.

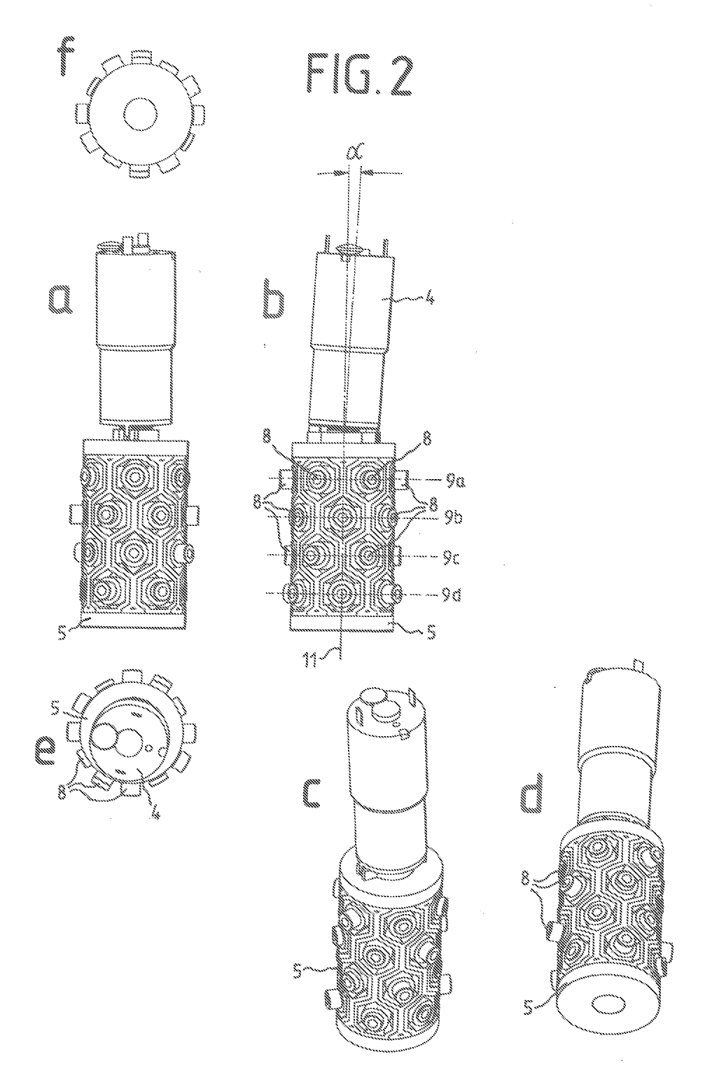

In particular, details of an embodiment of a device 5 for generating deformations of the rubber-elastic outer sheath 3 can be taken from the different views of FIG. 2. There is shown that a multitude of, in an axial direction referred to the massage section 2 or the device 5 for generating deformations, spaced plunger guiding planes 9a, 9b, 9c, 9d are provided. In this embodiment, these are four plunger guiding planes 9a, 9b, 9c, 9d. In this embodiment, furthermore six plunger guides 8 are provided inside every plunger guiding plane 9a, 9b, 9c, 9d. The plunger guides 8 of adjacent plunger guiding planes 9a, 9b, 9c, 9d are centrally displaced relative to each other. By comparing FIGS. 2a and 2b or also FIGS. 2c and 2d, it can be seen, like in FIG. 1, that the electromotive drive 4 or the output axis 6 thereof is tilted by the angle a relative to the central axis 11 of the device 5 for generating deformations of the rubber-elastic outer sheath 3. It can however also be seen that in this embodiment the cam shaft comprises in every plunger guiding plane 9a, 9b, 9c, 9d two opposed cams. Of course, with respect to the number and arrangement of the cams on the cam shaft, arbitrary variations are possible, according to a massage pattern to be adjusted. Furthermore, it can be seen that the cams on the cam shaft, with respect to different plunger guiding planes, may be rotated relative to each other or not.

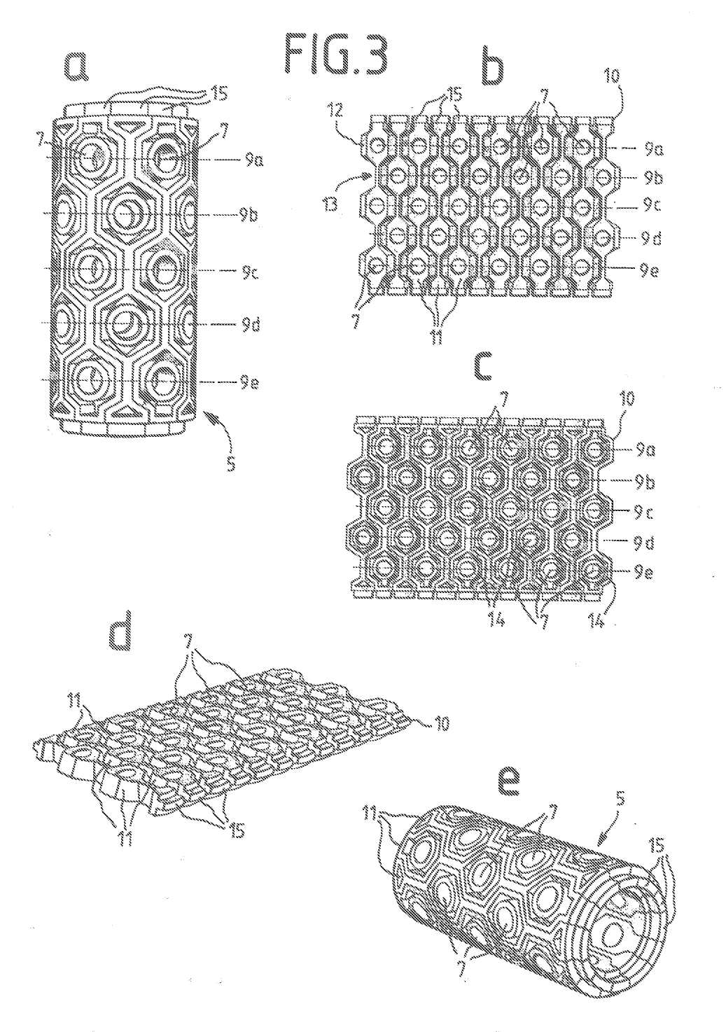

In FIG. 3, different views of the configuration of plunger guides 7 in a particularly advantageous embodiment are shown. The arrangement of the plunger guides 7 is formed by a mat 10 to be produced in a simple way by an injection-molding process (FIGS. 3b, 3c and 3d). In this embodiment, in total five plunger guiding planes 9a, 9b, 9c, 9d, 9e are provided. The mat 10 is provided with segments 11 extending in the direction of the longitudinal extension of the sleeve 5 with the plunger guides 7. These segments 11 are connected by so-called film hinges, so that the mat 10 can finally be shaped as shown in FIG. 3a or 3e. Inside, the segments 11 have complementary projections 12 and indentations 13, which in a rolled-up condition according to FIGS. 3a and 3e intermesh with each other (see also FIG. 3b). The film hinges are arranged outside opposite to these projections 12 and indentations 13 and thus permit the rolling-up according to FIGS. 3a and 3e. Outside are provided cutaways 14 of the actual sleeve guides 7 opposite to the supporting structures of the segments 11, reference being made in particular to FIGS. 3c as well as 3a and 3e. Finally, it can be seen in all figures that every segment 11 is provided on both sides with a fixing portion 15, and a (not shown) end cap can be fitted according to FIG. 3a or 3e at a respective end over the entirety of all fixing portions 15.

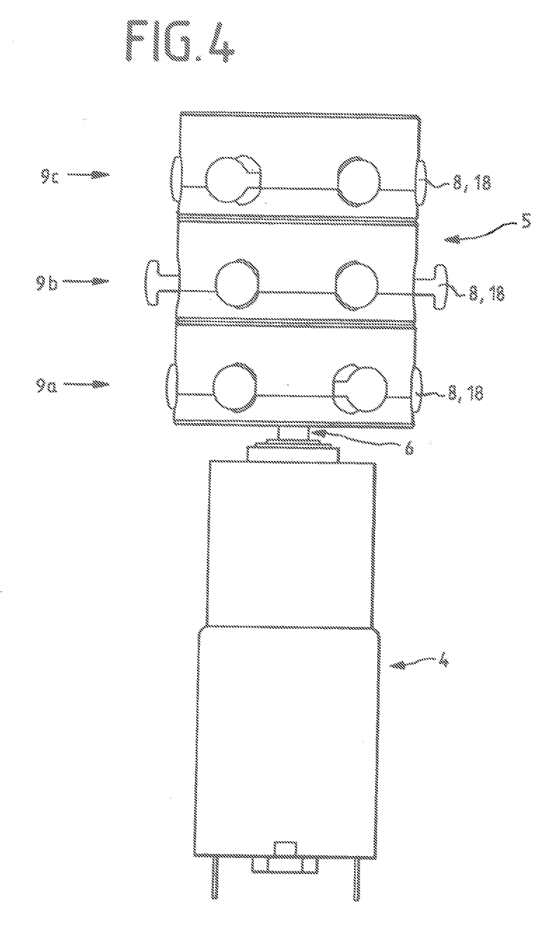

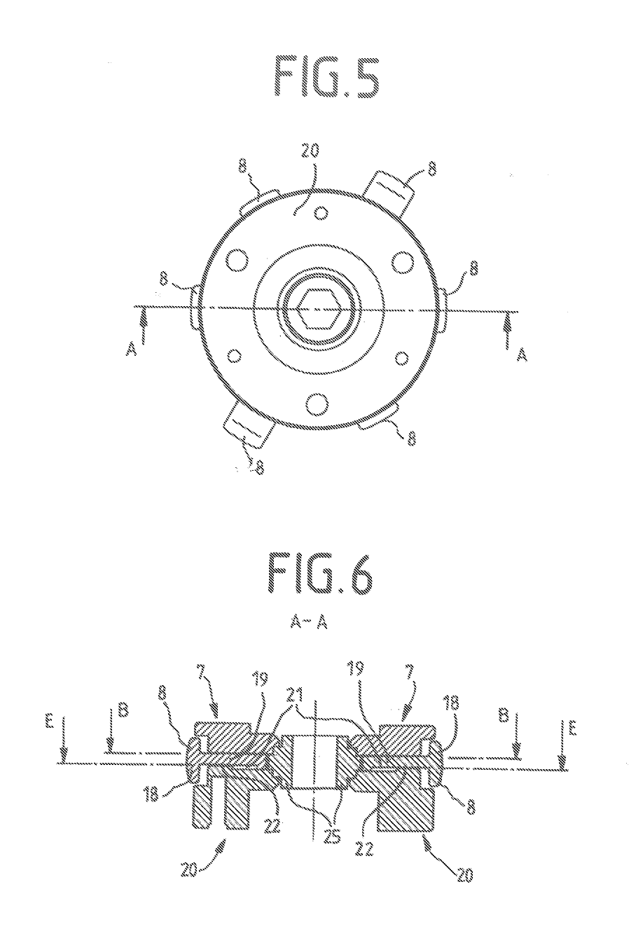

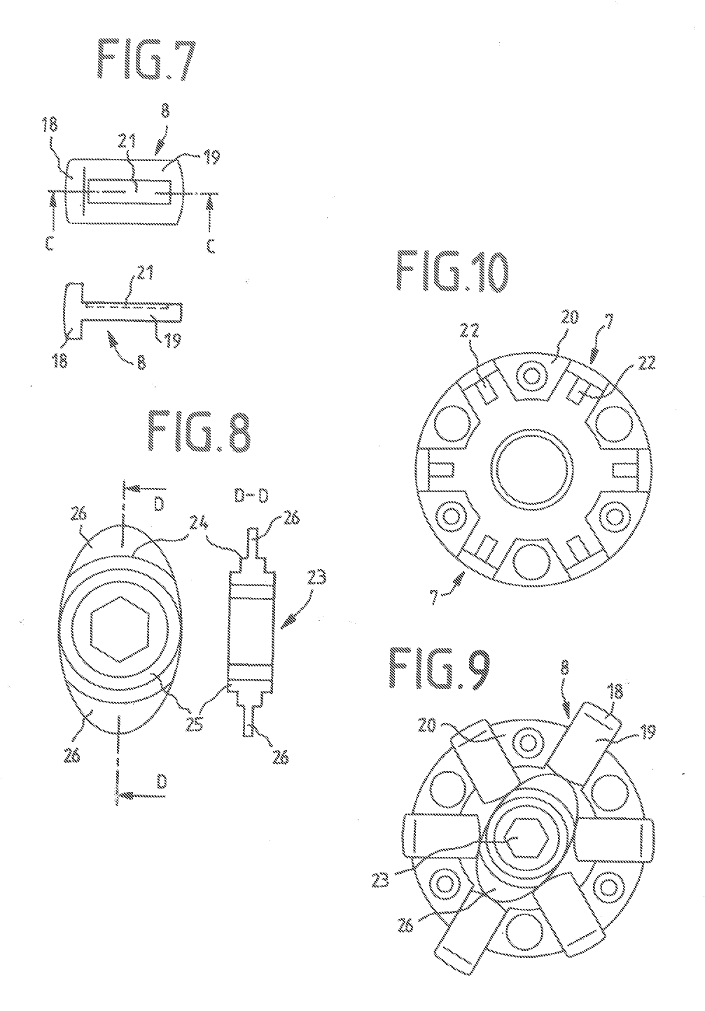

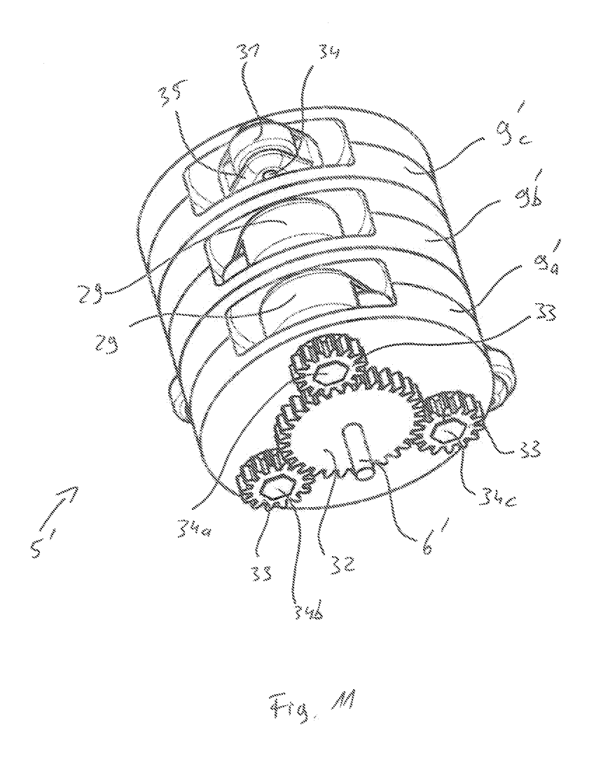

In FIG. 4, an alternative embodiment of an assembly comprising an electromotive drive 4 and a device 5 for generating deformations is shown. Firstly, it can be seen that a drive shaft 6 of the electromotive drive 4 is guided into the device 5 for generating deformations. This drive shaft 6 engages in cam wheels 23 that are respectively mounted in a plunger guiding plane 9a, 9b, 9c, as will be shown in the further figures explained below. In this embodiment, the plungers 8 with plunger heads 18 can be seen. By means of the drive shaft 6, the cam wheels 23 are rotatably driven with the consequence that the plungers 8 or plunger heads 18 are moved back and forth, as diagrammatically shown in FIG. 4.

FIG. 5 is a view in the direction of the front face of the subject matter of FIG. 4, viewed from above in the figure. Firstly, it can be seen that a segment housing 20 is provided, in which in this embodiment in total six plungers 8 are mounted. A sectional drawing of this plunger guiding plane 9c in plane A-A is shown in FIG. 6.

The basic structure can in particular be understood when comparing FIGS. 6, 9 and 10. For this purpose, FIGS. 7 and 8 include detailed representations of a plunger as well as of a cam wheel. These two components will now be explained.

In FIG. 7 can be seen that a plunger 8 is basically composed of a plunger head 18 and a plunger shaft 19. The plunger head 18 is essentially cylindrical. The plunger shaft 19 is essentially parallelepiped-shaped, the plunger shaft 19 having, in a first direction vertically to the longitudinal extension, in particular a width that corresponds to the radius of the plunger head 18. Vertically thereto (FIG. 7b), the plunger shaft 19 is however narrower or flatter. Comparing FIGS. 7a and 7b, it can be seen that the plunger shaft 19 comprises a guide recess 21. In this guide recess 21 engages a guide lug 22 of the segment housing 20, reference being made to FIG. 6. By co-operation of guide lug 22 and guide recess 21 in the assembled condition, the plungers 8 are guided in the plunger guides 7 not only in a non-rotatable, but also in a limited way in the radial direction of movement. As a result, a plunger 8 cannot fall out from a plunger guide 7.

In FIG. 8, a cam wheel 23 is shown. This cam wheel 23 essentially comprises a cam wheel body 25, a guide radius 24 as well as cams 26. In the rotary movement, given by the guide radius 24, the cam wheel 23 is guided axially as well as radially in the segment housing 20. When the cam wheel 23 rotates, the cams 26 revolve in the segment housing 20 and operate or displace the plungers 8, as can be seen in FIG. 8.

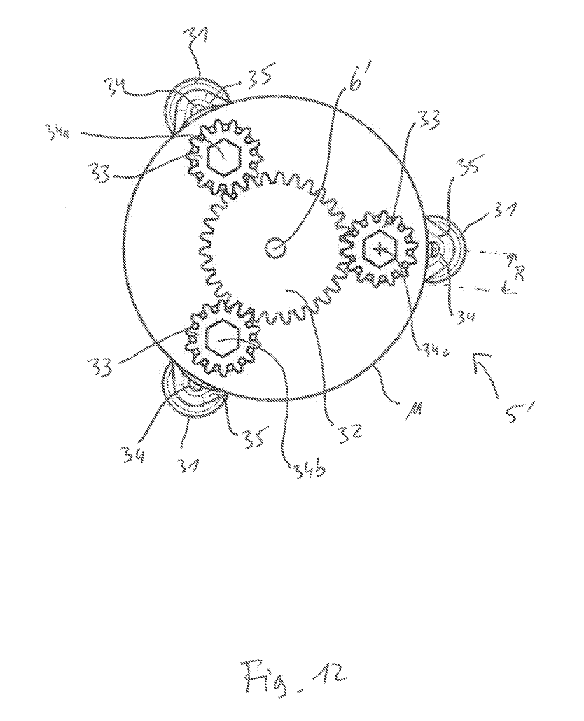

Comparing FIGS. 4, 6 and 10, it can be seen that a segment housing 20 is composed of a segment housing portion 27 as well as of a segment housing lid 28. FIG. 10 shows a view of a segment housing portion 27, in which plunger guides 7 and guide lugs 22 can be seen. After inserting the plungers 8 and the cam wheel 23, then a segment housing lid 28 is brought in place and connected with the segment housing portion 27.

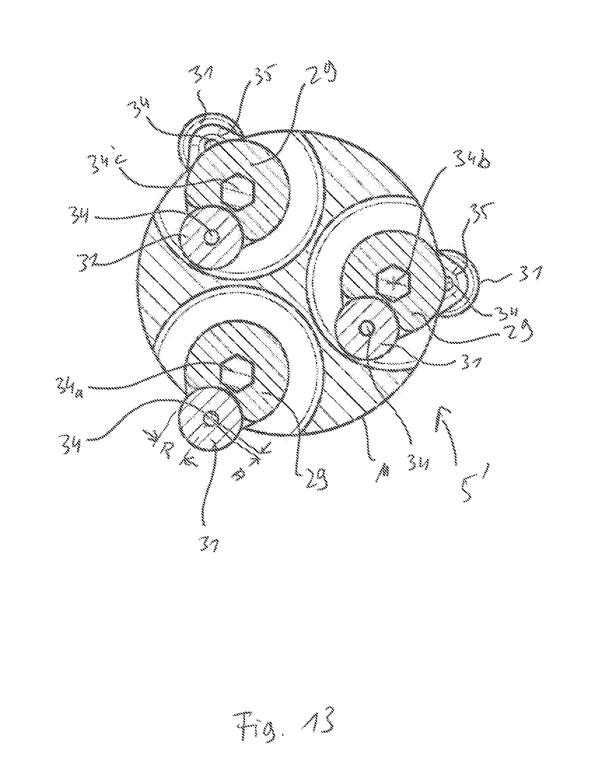

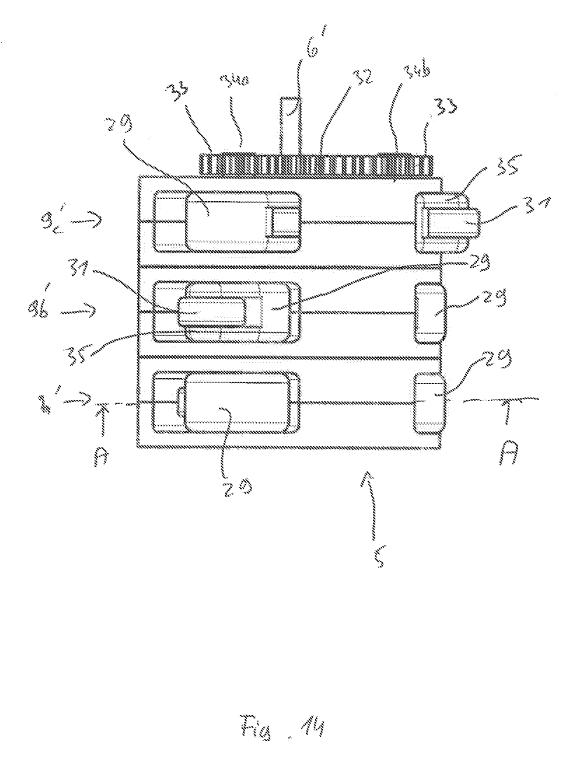

FIG. 11 shows an alternative embodiment of a device 5′ for generating deformations of a rubber-elastic outer sheath 3 that can be used in an analogous manner in the subject matters of FIGS. 1 and 4. Firstly, it can be seen that a drive shaft 6′ of the (not shown here) electromotive drive 4 is guided into the device 5′ for generating deformations. This drive shaft 6′ engages in a central gear 32 that is mounted at a front face of the device 5′. In the teeth thereof engage star gears 33, which are respectively non-rotatably mounted on an eccentric wheel axis of rotation 34a, 34b, 34c being parallel to the axis of the drive shaft 6′. On the eccentric wheel axes of rotation 34a, 34b, 34c are in turn mounted in every eccentric wheel plane 9a′, 9b′, 9c′ respective eccentric wheels 29 in an axially spaced and non-rotatable manner. Likewise, of course, an arrangement of the central gear 32 and the star gears 33 between two eccentric wheel planes 9a′, 9b′, 9c′ would be possible. Comparing FIGS. 11 to 14, it can be seen that the eccentric wheels 29 each carry an eccentric bearing pin 34 and that in a support cage 35 extending radially over the outer circumference of the eccentric wheel. The axes of the eccentric bearing pins 34 are oriented in parallel to the eccentric wheel axes of rotation 34a, 34b, 34c. On the eccentric bearing pins is mounted one roller wheel 31 each. The outer circumference of each eccentric wheel 29 outside the range carrying a roller wheel 31 does not protrude beyond an outer surface M of the device 3′ for generating deformations of the rubber-elastic outer sheath and revolves immediately inside the outer surface M. A roller wheel 31 has a radius R that is greater than the distance A of the eccentric wheel axis of rotation 34a, 34b, 34c from the outer circumference of the eccentric wheel 29, provided that the eccentric wheel axis of rotation 34a, 34b, 34c is inside or on the outer circumference of the eccentric wheel 29. In this embodiment, A is zero. The components of the support cage 35 do not protrude, viewed in an axial projection (FIGS. 12 and 13), beyond the roller wheel.

1. A massage device comprising:
at least one massage section with an essentially cylindrical rubber-elastic outer sheath;
at least one electromotive drive arranged in the massage device and non-rotatably mounted therein; and
a device arranged in said massage section and non-rotatably mounted therein for generating deformations of the rubber-elastic outer sheath,
wherein said device includes a multitude of plunger guides extending radially to the massage section and supporting plungers therein, and a cam shaft connected with said electromotive drive and acting on the ends of the plungers facing away from the rubber-elastic outer sheath, thereby the plungers being radially moved towards said massage section, or
wherein said device includes a multitude of eccentric wheels to be rotatably driven by means of said electromotive drive, which eccentric wheels include at least one freely rotatable roller wheel each supported on at least one eccentric bearing pin, wherein the roller wheel acts on the inside of the rubber-elastic outer sheath and moves it radially towards the massage section, and
wherein the rubber-elastic outer sheath is connected with the ends of the plungers facing towards the rubber-elastic outer sheath or with the roller wheel at least during the deformation of the rubber-elastic outer sheath.

2. The massage device according to claim 1, wherein in said device for generating deformations of the rubber-elastic outer sheath, a multitude of, in an axial direction referred to the massage section, spaced plunger guiding or eccentric wheel planes are provided.

3. The massage device according to claim 2, wherein the number of the plunger guiding or eccentric wheel planes is in the range from 2 to 20.

4. The massage device according to claim 2, wherein the number of the plunger guides or eccentric wheels in each plunger guiding or eccentric wheel plane is identical or different and is between 2 and 20.

5. The massage device according to claim 2, wherein the plunger guides of adjacent plunger guiding planes are displaced relative to each other, in particular centrally displaced relative to each other.

6. The massage device according to claim 1, wherein an axis of rotation of the electromotive drive is tilted by an angle a in the range from 0° to 20°, with respect to the axis of the device for generating deformations of the rubber-elastic outer sheath.

7. The massage device according to claim 1, wherein the rubber-elastic outer sheath and its connection with the ends of the plungers facing towards the rubber-elastic outer sheath are adapted such that the return forces and return travels of the rubber-elastic outer sheath are adapted for a complete return of the plungers.

8. The massage device according to claim 1, wherein an operating and/or control unit, if applicable including an electrical energy storage, is provided for controlling said electromotive drive, and wherein the operating and/or control unit and the electromotive drive on the other hand are mounted on opposite sides or ends of the device for generating deformations of the rubber-elastic outer sheath.

9. The massage device according to claim 1, wherein a remote control unit is provided that is connected with said operating and/or control unit by electrical and/or optical cables or by electromagnetic waves.

10. A massage device having an essentially cylindrical rubber-elastic outer sheath, the device comprising:
at least one massage section;
at least one electromotive drive non-rotatably mounted in the massage device; and
a device arranged in said massage section and non-rotatably mounted therein for generating deformations of the rubber-elastic outer sheath,
wherein said device includes a multitude of plunger guides extending radially to the at least one massage section and supporting plungers therein, and
wherein said electromotive drive connects with a cam shaft to act on ends of the plungers facing away from the rubber-elastic outer sheath, thereby the plungers being radially moved towards said at least one massage section, and
wherein the rubber-elastic outer sheath is connected with the ends of the plungers facing towards the rubber-elastic outer sheath at least during the deformation of the rubber-elastic outer sheath.

11. The massage device according to claim 10, wherein in said device for generating deformations of the rubber-elastic outer sheath, a multitude of, in an axial direction referred to the massage section, spaced plunger guiding planes are provided.

12. The massage device according to claim 11, wherein the number of the plunger guiding planes is in the range from 2 to 20.

13. The massage device according to claim 11, wherein the number of the plunger guides or eccentric wheels in each plunger guiding plane is identical or different and is between 2 and 20.

14. A massage device having an essentially cylindrical rubber-elastic outer sheath, the device comprising:
at least one massage section;
at least one electromotive drive non-rotatably mounted in the massage device; and
a device arranged in said massage section and non-rotatably mounted therein for generating deformations of the rubber-elastic outer sheath,
wherein said device includes a multitude of plunger guides extending radially to the at least one massage section and supporting plungers therein, and
wherein said device includes a multitude of eccentric wheels to be rotatably driven by means of said electromotive drive, which eccentric wheels include at least one freely rotatable roller wheel each supported on at least one eccentric bearing pin, wherein the roller wheel acts on the inside of the rubber-elastic outer sheath and moves it radially towards the massage section, and
wherein the rubber-elastic outer sheath is connected with the roller wheel at least during the deformation of the rubber-elastic outer sheath.

15. The massage device according to claim 12, wherein in said device for generating deformations of the rubber-elastic outer sheath, a multitude of, in an axial direction referred to the massage section, spaced eccentric wheel planes are provided.

16. The massage device according to claim 15, wherein the number of the eccentric wheel planes is in the range from 2 to 20.

17. The massage device according to claim 15, wherein the number of the plunger guides or eccentric wheels in each eccentric wheel plane is identical or different and is between 2 and 20.
